(19) United States
(12) Patent Application Publication
(10) Pub. No.: US 2005/0098193 A1
(43) Pub. Date: May 12, 2005

(54) Hollow cylinder toothpick

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/704,926

(22) Filed: Nov. 10, 2003

(51) Int. Cl. A61C 15/00

(52) U.S. Cl. 132/322

(57) ABSTRACT

A hollow body toothpick comprising a hollow elongated cylindrical body made with plastic material with one or both ends flattened and sealed. If both ends of the hollow elongated cylindrical body are sealed, the hollow elongated cylindrical body may enclose a fluid such as a mouth wash in its sealed enclosure.

### BACKGROUND

1. Field of Invention

The present invention relates generally to a toothpick. More specifically the present invention relates to a toothpick made with a hollow tube.

2. Description of Related Art

Toothpick generally comprises of a solid elongated body with two pointed ends. Conventional toothpicks have a round solid body most commonly made of wood and two sharp conical pointed ends for insertion into the crevice between teeth to remove particles therein.

### SUMMARY OF THE INVENTION

The present invention is a hollow body toothpick with one or more flat ends that can be mass produced very economically and quickly. The hollow cylinder toothpick comprises of a hollow elongated cylindrical body made with plastic material with one or both ends flattened and sealed. If both ends of the hollow elongated cylindrical body are sealed, the hollow elongated cylindrical body may enclose a fluid such as mouth wash in its sealed enclosure.

### BRIEF DESCRIPTION OF THE DRAWINGS

FIG. 1 shows the preferred embodiment of the hollow cylinder toothpick.

FIG. 2 shows another embodiment of the hollow cylinder toothpick.

FIG. 3 shows another embodiment of the hollow cylinder toothpick.

### DETAILED DESCRIPTION OF THE PREFERRED EMBODIMENT

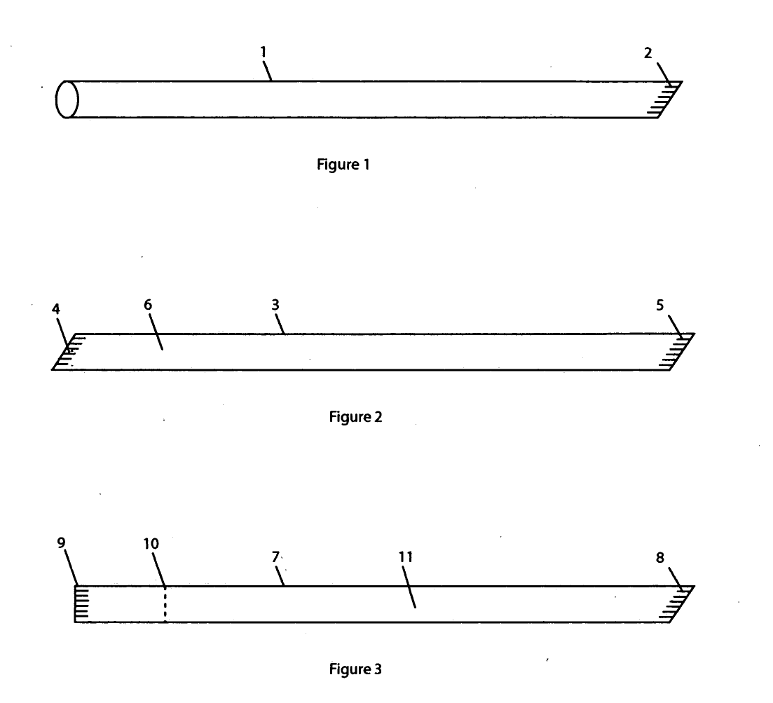

FIG. 1 shows the preferred embodiment of the present invention. In the preferred embodiment, the hollow cylinder toothpick comprises of a hollow elongated cylindrical body 1 made with plastic material with one end 2 flattened and formed at an angle to produce a sharp pointed edge. The flattened sharp pointed edge may be used as a toothpick for insertion into the crevice between teeth to remove particles therein. The flattened end 2 may also be formed in a fan shape, spreading out from the end of the hollow elongated cylindrical body 1. The flattened end 2 may also be sealed such as by heating the end of the plastic hollow elongated cylindrical body 1 while simultaneously applying pressure to close the end 2.

FIG. 2 shows another embodiment of the present invention. In this embodiment, the hollow cylinder toothpick comprises of a hollow elongated cylindrical body 3 made with plastic material with both ends 4, 5 flattened and each formed at an angle to produce a sharp pointed edge at each end 4, 5. The flattened ends 4, 5 may also be formed in a fan shape, spreading out from the end of the hollow elongated cylindrical body 3. The flattened ends 4, 5 may also be sealed such as by heating the end of the plastic hollow elongated cylindrical body 3 while simultaneously applying pressure to close the ends 4, 5. A fluid 6 such as mouth wash may be enclosed within its sealed enclosure wherein when one sealed end of the hollow elongated cylindrical body 3 is torn or cut away, the enclosed fluid 6 may be sucked out of the hollow elongated cylindrical body 3 for use.

FIG. 3 shows another embodiment of the present invention. In this embodiment, the hollow cylinder toothpick comprises of a hollow elongated cylindrical body 7 made with plastic material with one end 8 flattened and sealed at an angle to produce a sharp pointed edge at the end 8. The other end 9 may be simply sealed with an opening means 10 such as a fracture line positioned near the sealed end 9. The flattened end 8 and the sealed end 9 may also be formed in a fan shape, spreading out from the end of the hollow elongated cylindrical body 7. A fluid 11 such as mouth wash may be enclosed within the sealed enclosure wherein when the opening means 10 is opened such as through bending and breaking the hollow elongated cylindrical body. 7 at the fracture line 10, the enclosed fluid 11 may be sucked out of the hollow elongated cylindrical body 7 for use.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A hollow cylinder toothpick comprising a hollow elongated cylindrical body with one end flattened and formed at an angle to produce a sharp pointed edge whereby said flattened sharp pointed edge may be used as a toothpick for insertion into the crevice between teeth to remove particles therein.

2. A hollow cylinder toothpick as in claim 1, wherein said hollow elongated cylindrical body is made of plastic.

3. A hollow cylinder toothpick as in claim 1, wherein said flattened end is formed in a fan shape that spreads out from the end of the hollow elongated cylindrical body.

4. A hollow cylinder toothpick as in claim 1, wherein said flattened end is sealed.

5. A hollow cylinder toothpick comprising a hollow elongated cylindrical body with two ends wherein both ends are flattened and formed at an angle to produce a sharp pointed edge at each end whereby said flattened sharp pointed edges may be used as a toothpick for insertion into the crevice between teeth to remove particles therein.

6. A hollow cylinder toothpick as in claim 5, wherein said hollow elongated cylindrical body is made of plastic.

7. A hollow cylinder toothpick as in claim 5, wherein said flattened end is formed in a fan shape that spreads out from the end of the hollow elongated cylindrical body.

8. A hollow cylinder toothpick as in claim 5, wherein said flattened ends are sealed.

9. A hollow cylinder toothpick as in claim 8, wherein a fluid is disposed within the hollow elongated cylindrical body.

10. A hollow cylinder toothpick comprising a hollow elongated cylindrical body with a first end flattened and sealed at an angle to produce a sharp pointed edge at the end and a second sealed end whereby said flattened sharp pointed edges may be used as a toothpick for insertion into the crevice between teeth to remove particles therein.

11. A hollow cylinder toothpick as in claim 10, wherein said hollow elongated cylindrical body is made of plastic.

12. A hollow cylinder toothpick as in claim 10, wherein said flattened end is formed in a fan shape that spreads out from the end of the hollow elongated cylindrical body.

13. A hollow cylinder toothpick as in claim 10, wherein said flattened end is sealed.

14. A hollow cylinder toothpick as in claim 13, wherein an opening means is provided near said sealed end and a fluid is disposed within the hollow elongated cylindrical body.

15. A hollow cylinder toothpick as in claim 14, wherein said opening means is a fracture line.
